(19) United States
(12) Patent Application Publication
(10) Pub. No.: US 2005/0169537 A1
(43) Pub. Date: Aug. 4, 2005

(54) SYSTEM AND METHOD FOR IMAGE BACKGROUND REMOVAL IN MOBILE MULTI-MEDIA COMMUNICATIONS

(75) Inventor: Cherif Keramane, Morrisville, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/708,018

(22) Filed: Feb. 3, 2004

(51) Int. Cl. G06K 9/36

(52) U.S. Cl. 382/232

(57) ABSTRACT

A method and an apparatus to carry out the method that enables a mobile phone to reduce the bitrate of an image to be transmitted by the mobile phone. The method first removes a portion of an original image frame thereby creating dead clusters within the image frame. The dead clusters are then filled with data to create a new image frame having a smaller bitrate than the original image frame. The new image frame is then encoded such that it requires less bandwidth during transmission than the original image frame would require.

### BACKGROUND OF INVENTION

Current cellular and wireless systems are evolving toward more support of multimedia services. In particular, most mobile devices have an embedded camera or the ability to plug and use a camera accessory. This enables interpersonal video communication, including exchange of video clips and images, and real-time video-conferencing sessions. However, the current state of the cellular networks do not utilize relatively high data rates, which limits considerably their quality, functionality or both. Even in next generation networks, higher bandwidth will remain a critical resource and any technique striving to efficiently use it will be useful.

### SUMMARY OF INVENTION

The present invention addresses the case of images or video clips of a subject with a common, i.e., fairly still, background. Such data is usually encoded (e.g. into jpeg for images, H.263 or mpeg-4 for video clips or videophone bitstream) before being sent as a multi-media message (MMS) or in real time during a videophone session. The present invention demonstrates how a unique and novel combination of existing algorithms can be used to reduce the bitrate of the resulting bitstream for image data.

To achieve this purpose the mobile phone includes a processor, a processor readable storage medium, and code recorded in the processor readable storage medium. The code recorded in the processor readable storage medium includes code to remove a portion of an original image frame thereby creating dead clusters within the image frame. The dead clusters are then filled with data to create a new image frame having a smaller bitrate than the original image frame. The new image frame is then encoded such that it requires less bandwidth during transmission than the original image frame would require. The data used to fill the dead clusters can be white data or black data.

To assist the receiver of the transmitted image in reconstructing the image, the sending mobile phone can optionally include a representation of the removed portion of the original image frame with the new image frame.

The method works best for images that include a primary subject centered in the image frame. The present invention therefore includes a step or process for automatically detecting whether there is a subject centered in the original image frame prior to executing the bitrate reduction software application on the original image frame. If there is a centered subject the mobile phone will execute the bitrate reduction software application automatically. A contour detection technique is applied to the data in the image frame to automatically determine whether there is a subject centered in the original image frame.

### BRIEF DESCRIPTION OF DRAWINGS

FIG. 1 is a front view of a typical mobile phone.

FIG. 2 is a rear view of a typical mobile phone shown with an embedded camera.

FIG. 3 is a block diagram illustrating components and functions of the present invention.

### DETAILED DESCRIPTION

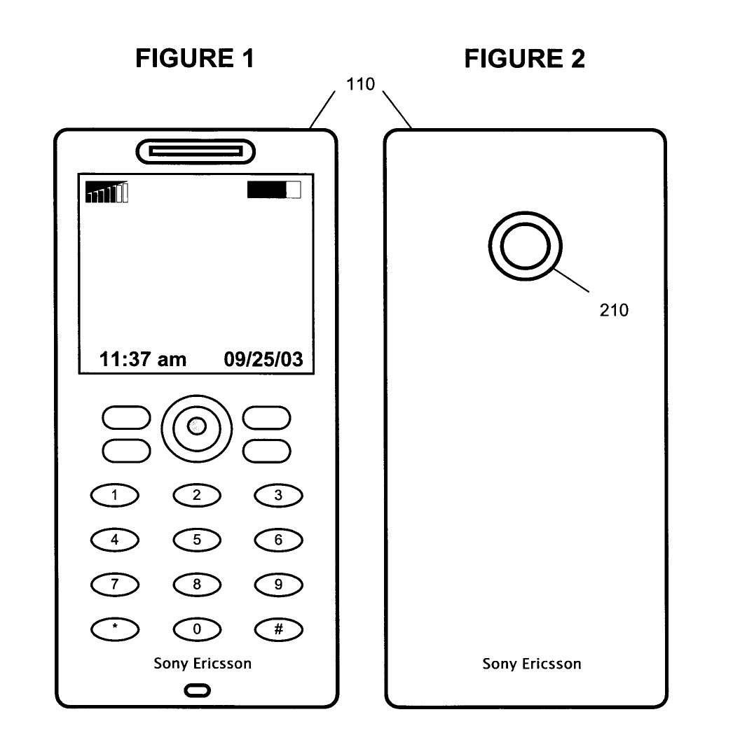

FIG. 1 is a front view of a typical mobile phone 110. The mobile phone 110 is shown here to help provide a context for the present invention. FIG. 2 is a rear view of the typical mobile phone 110 shown with an embedded camera 210. The camera 210 is capable of taking still images and may even be able to record video clips. The images and/or video clips can then be transmitted to other mobile phones or computer devices.

The chief technological obstacle to providing the user with a satisfying experience is the bandwidth necessary to transmit and receive video images such that the images are not too distracting or time consuming for the user. Cellular or wireless networks are bandwidth constrained when it comes to data exchanges. Thus, any improvements regarding image transmission are greatly valued. One common way to maximize bandwidth is to compress the images or video as much as possible without overly sacrificing image quality. Data compression, however, must be practiced judiciously or the user experience can deteriorate to the point of non-enjoyment.

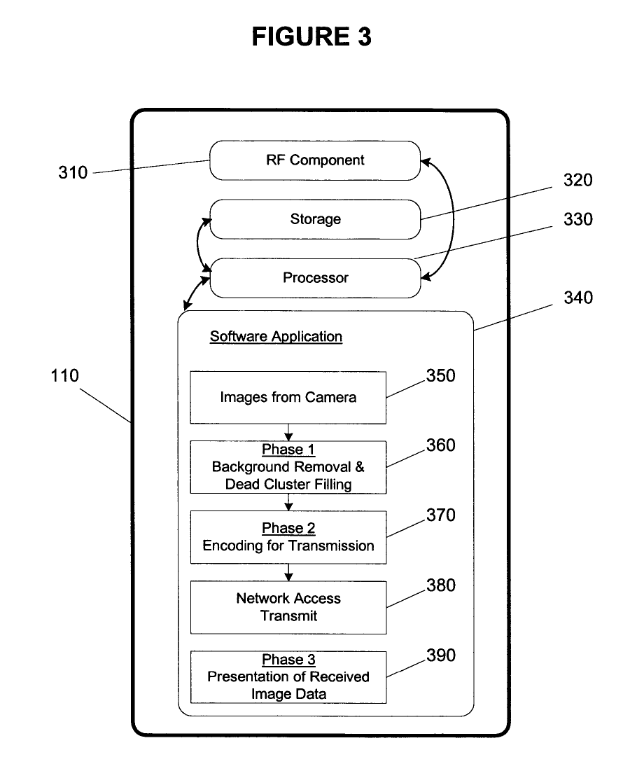

FIG. 3 is a block diagram illustrating the functions of the present invention. The embedded camera (or a camera attachment) 210 produces images (stills or video) 350 and forwards the images to a bitrate reduction software application 340 residing within the mobile phone 110. The bitrate reduction software application is split into three phases. The first two phases address the encoding and transmission of captured images while the third phase addresses the presentation of received image data that has been encoded according to the previous phases. The software application is executed by a processor 330 that has access to and control over a storage medium 320 and an RF component 310.

Phase one 350 concerns pre-processing an image, or a frame of a captured video stream, before its encoding, for removal of non-relevant areas. This includes background removal and filling the removed areas (dead clusters) with appropriate data. Filling the dead clusters with appropriate data will enable bandwidth efficiency during the upcoming encoding phase. Phase two 360 involves encoding the data using traditional techniques, which will prove more efficient given the dead cluster filling that occurred in the previous phase. Phase three 390 presents transmitted data in a way that will minimize the impact of the removed areas.

When a frame is captured using the embedded camera (or attachable camera accessory), a background removal algorithm is applied to the image data in the frame. Background removal algorithms are well known in the art and can be found, for instance, in Background Removal in Image Indexing and Retrieval, 10^{th} International Conference on Image Analysis and Processing, Udine, Italy, 1999. This will result in a set of clusters described herein as a CL-list, that correspond to the background of an image. This portion of the image is not particularly relevant for transmission to another mobile phone.

Typically, the image encoding scheme is block based. If encoding of the image is block based (e.g. 8×8 blocks in jpeg or mpeg-4), the largest set of 8×8 blocks contained in the clusters of the CL-list is deduced and a new list of clusters (CL-list-B) is generated. This will ensure that partial blocks at the edge of the background area are not considered since they would be ignored by the encoding algorithm. At this stage there is a list of rectangular clusters whose shape fits the block shape used by the encoding algorithm. Note, if the encoding algorithm is not block based, the CL-list is kept as is.

The next step is to fill all the blocks contained in the CL-list-B (or all the clusters of the original CL-list) with pure white pixels. These all-white areas will be optimally encoded as will be shown in phase 2. This step is termed “dead cluster filling”. There is now a new version of the image frame where all background data has been replaced with pure white data.

It should be noted that in the case of DCT-based encoding algorithms like jpeg, mpeg-1, mpeg-2, mpeg-4 and H.263, an all-black filling would work too. As will be seen in the next step, it is most important that the generated bitstream enable optimal entropy or arithmetic encoding, i.e., any bit based lossless encoding shrinking consecutive redundant bits.

When the encoding is performed using jpeg (for still images), or mpeg or H.263 (for clips), a discrete cosine transform (DCT) of the encoding will encounter all the background blocks of CL-list-B as blank blocks, namely containing only color components set to 0. The block is thus unchanged. When serialized, this block will yield a continuous zero bitstream that will be optimally encoded using a Lempel Ziv Welch (LZW), Huffman, or Arithmetic encoding scheme as the last processing step of the compression algorithm. This achieves a significant bitstream reduction compared to the actual background that not only contains non-zero color components, but is likely discontinuous as well (i.e. containing very few connected color-homogeneous areas).

When considering future evolutions of encoding algorithms, all linear transforms (such as Fourier transforms) transform a null vector into a null vector, their kernel being reduced exclusively to the null vector when the transforms are non-degenerate. This is usually the case in their discrete forms as well like a DCT deduced from a fast fourier transform (FFT). It is thus possible to use the technique of the present invention and obtain the same bandwidth improvement with any kind of linear digital block transform.

The algorithm is also applicable to non-block based non-DCT based techniques like fractal compression. Fractal compression segments the image into a mesh made of a chosen basic shape (usually triangles). Phase one will, in that case, deduce CL-list-B from the original CL-list using these shapes rather than blocks. Subsequent encoding still yields optimal results since all the basic shapes contained in the background will be self similar up to an affine transform, thereby achieving high compression in the fractal compression spirit.

A refinement of the block-based case can be added when using advanced profiles of mpeg-4 encoding or similar techniques using non-rectangular objects. In such a case, the non rectangular object complementing the clusters in the image (i.e. the actual contour of the person talking) will be coded as a non rectangular object by itself and the background will be entirely stripped of the encoded bitstream (i.e. no dead cluster filling is necessary in that case).

When the encoding is done, the image is ready for transmission. Except in the refined mpeg-4 case with non rectangular objects (where it is not necessary), the cluster list CL-list-B can be sent with the encoded data to enable better presentation of the received data, but this is not necessary for the technique to work.

At this point the data is ready to be transmitted. The transmission technique is irrelevant to the invention described here, and both asynchronous (like MMS) and synchronous (like videophone session) transmission modes will benefit from the bitsize/bitrate reduction. Although the technique seems more suitable for video telephony or centered foreground object clips (like newscast, speeches, advertisement of sample items, etc . . . ), a still image transmission (e.g. through MMS) can also benefit from a size reduction if the transmitted data size is upper bounded like in the current versions of MMS.

When image data is received at the other end of the transmission, each frame (or a single frame if it is still image), when decoded, will contain only the relevant data with the removed background set to pure white (or no background at all in the advanced mpeg-4 profile case). At this point the CL-list-B corresponding to each image could have been sent or not. The CL-list-B is relatively small describing only a list of gross rectangular areas, and thus introducing very low overhead on transmission bandwidth. In particular, this overhead is significantly small compared to the gain achieved by removing the background.

There are many options for presenting the received image to the mobile user. A few are presented herein. The first, and simplest, is to present the image frames exactly as received, i.e. with a pure white background, or replacing the background with a solid color (or solid texture) more suitable to the mobile phone. The background can also be replaced with a predefined set of backgrounds stored on the receiving mobile phone device. Users could have the option to choose from a list of themed backgrounds. Another option is to alpha-blend the received frames with the current mobile phone background considering the pure white background as a transparent color. Or, an artificial noise pattern can be added to the background so that it fits in with the noise level of the viewing area. For example, the signal-to-noise ratio (SNR) of the visible area can be chosen, and an artificial noise pattern (like a blur algorithm) can be applied to fit that particular SNR. Still another option is to smooth or blur the edges of the frame foreground to avoid the blocking effect produced at the edge of the relevant part of the image by removing the background. Another possibility is to apply a contour detection on the foreground. The areas beyond the contour of the talking person can either be removed, or smoothed/blurred, or fused with background. Smoothing can be performed using a median filter. Contour detection can be performed using a classical canny algorithm or shen-castan. Blur can be achieved by applying a zeromean Gaussin noise on small patches, whose noise level can easily be set to a pre-determined value (SNR is related to the Gaussian variance), the process being repeated on all patches.

In the aforementioned options, one or more of these techniques can be combined to present the user a better viewing experience. All the options have different complexities and produce different levels of perceived quality. The associated compromises are a matter of product design.

The effectiveness of the present invention is enhanced if a main object is centrally framed against a relatively still background. A man/machine interface (MMI) feature within the software application could explicitly ask the user to activate efficient compression only in this setting. A refinement of this technique will include a phase zero (0), preceding phase one, which will describe a means for automatically detecting this user case option, thus activating automatically the algorithm when needed.

Note also that the present invention can be used in newscasts prepared for mobile phone users for transmission over wireless networks. In this case, editors of the newscast can activate the feature explicitly when a news anchor is addressing the audience and disable it when other footage is included. In this case phase zero is not necessary.

The purpose of phase zero is to automatically determine the case of a slow motion clip where a foreground object is in the center of the camera that captured the images. This corresponds mainly to the video phone session case or the newscast speech case. Other cases with a relatively still background and centered object of interest (e.g., a relatively still automobile) can also benefit from the technique.

To detect whether there is a centered subject in a frame, the present invention employs a contour detection algorithm. If the most massive shape (i.e., the one with the highest inertia moments) is centered in the image and the shapes close to the background have small inertia moments, then there is a centered object in the image frame. Contour detection can be achieved using techniques such as, for instance, a Canny & Deriche operator or a Shen & Castan operator. Other contour detection techniques well known in the art may be implemented as well.

A refinement of phase zero accommodates lower processing power in a mobile phone. The detection algorithm here above would be activated only intermittently when needed instead of for each frame. The mobile phone would activate the detection at the first frame, when the user opens the session. Enter in a state where the background removal is done (state A) or not (state B) depending on the result of the first detection.

For the subsequent frames, keep the same state, but compute for each frame its difference with the previous frame. If the difference is below a certain threshold set by engineering tests when building the software application, then the frames are deemed as possessing a similar motion level which indicates a similar state. The initial state A or B is thus kept.

When the threshold is above a certain value, indicating a gap in motion, the user could have switched to another mode of recording (like recording a landscape). The detection algorithm is thus run again to determine if switching to the other state is necessary. This results in activating or deactivating the background removal mode depending on the case.

With this refinement to phase zero, the detection algorithm is activated only when a motion level gap is perceived. Note that other techniques of detecting the level of motion between images can be used as well. The technique described here (frame differences threshold) only demonstrate feasibility. The present invention is not intended to be limited to this technique alone.

The foregoing has assumed that the image(s) to be compressed, encoded, and transmitted were acquired from an embedded or attached camera to the mobile phone. While that may be the most common situation, the present invention is not limited to operating on images captured by a camera associated with the mobile phone. Images and/or video clips that on the mobile phone that were created or acquired from other sources can readily make use of the techniques of the present invention. For instance, it is well within the capabilities of many mobile phones to exchange data directly with a personal computer using an RF connection such as Bluetooth™ or an infrared connection. These mechanisms allow a mobile phone user to exchange text, video, images, and/or audio with another computing device without using the cellular network.

It would not be uncommon for a mobile phone user to send an image from his personal computer to his mobile phone using one of the aforementioned mechanisms and then include the image in an MMS message to another mobile phone. In this scenario, the MMS transmission of the image can readily invoke the techniques of the present invention to reduce the bandwidth requirements of the MMS transmission.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Specific embodiments of an invention are disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

1. A mobile phone having a software application for reducing the bitrate of an image to be transmitted by the mobile phone, said mobile phone comprising:
a processor;
a processor readable storage medium;
code recorded in the processor readable storage medium to remove a portion of an original image frame thereby creating dead clusters within the image frame;
code recorded in the processor readable storage medium to fill the dead clusters of the removed portion of the image frame with data to create a new image frame having a smaller bitrate than the original image frame; and
code recorded in the processor readable storage medium to encode the new image frame such that it requires less bandwidth during transmission than the original image frame would require.

2. The mobile phone of claim 1 wherein the data used to fill the dead clusters is white data.

3. The mobile phone of claim 1 wherein the data used to fill the dead clusters is black data.

4. The mobile phone of claim 1 further comprising:
code recorded in the processor readable storage medium to include a representation of the removed portion of the original image frame with the new image frame during transmission of the new image frame so that it may be utilized by the receiver to improve the presentation of the received image frame by integrating it back into the received image frame.

5. The mobile phone of claim 1 further comprising:
code recorded in the processor readable storage medium to automatically determine whether there is a subject centered in the original image frame prior to executing the bitrate reduction software application on the original image frame; and
code recorded in the processor readable storage medium to execute the bitrate reduction software application if the original image is determined to contain a primary object centered in the image frame.

6. The mobile phone of claim 5 automatically determining whether there is a subject centered in the original image frame is achieved using a contour detection technique applied to the data in the image frame.

7. A method that enables a mobile phone to reduce the bitrate of an image to be transmitted by the mobile phone, said method comprising:
removing a portion of an original image frame thereby creating dead clusters within the image frame;
filling the dead clusters of the removed portion of the image frame with data to create a new image frame having a smaller bitrate than the original image frame; and
encoding the new image frame such that it requires less bandwidth during transmission than the original image frame would require.

8. The method of claim 7 wherein the data used to fill the dead clusters is white data.

9. The method of claim 7 wherein the data used to fill the dead clusters is black data.

10. The method of claim 7 further comprising:
including a representation of the removed portion of the original image frame with the new image frame during transmission of the new image frame so that it may be utilized by the receiver to improve the presentation of the received image frame by integrating it back into the received image frame.

11. The method of claim 7 further comprising:
automatically determining whether there is a subject centered in the original image frame prior to executing the bitrate reduction software application on the original image frame; and
executing the bitrate reduction software application if the original image is determined to contain a primary object centered in the image frame.

12. The method of claim 11 wherein automatically determining whether there is a subject centered in the original image frame is achieved using a contour detection technique applied to the data in the image frame.

13. An apparatus that enables a mobile phone to reduce the bitrate of an image to be transmitted by the mobile phone, said method comprising:
means for removing a portion of an original image frame thereby creating dead clusters within the image frame;
means for filling the dead clusters of the removed portion of the image frame with data to create a new image frame having a smaller bitrate than the original image frame; and
means for encoding the new image frame such that it requires less bandwidth during transmission than the original image frame would require.

14. The apparatus of claim 13 wherein the data used to fill the dead clusters is white data.

15. The apparatus of claim 13 wherein the data used to fill the dead clusters is black data.

16. The apparatus of claim 13 further comprising:
means for including a representation of the removed portion of the original image frame with the new image frame during transmission of the new image frame so that it may be utilized by the receiver to improve the presentation of the received image frame.

17. The apparatus of claim 13 further comprising:
means for automatically determining whether there is a subject centered in the original image frame prior to executing the bitrate reduction software application on the original image frame; and
means for executing the bitrate reduction software application if the original image is determined to contain a primary object centered in the image frame.

18. The apparatus of claim 17 wherein automatically determining whether there is a subject centered in the original image frame is achieved using a contour detection technique applied to the data in the image frame.
